(19) United States
(12) Patent Application Publication
(10) Pub. No.: US 2007/0110027 A1
(43) Pub. Date: May 17, 2007

(54) Systems and methods for processing packet streams

(75) Inventors: You-min Yeh, Keelung City (TW); Chih-chieh Yang, Taipei City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: MediaTek Incorporation

(21) Appl. No.: 11/274,440

(22) Filed: Nov. 15, 2005

(51) Int. Cl. H04L 12/28

(52) U.S. Cl. 370/351

(57) ABSTRACT

The present invention relates to packet stream processing systems and methods for multiple cascaded units. Each unit has a packet rate compensator to maintain a time interval of packets output from the unit approximately the same as a corresponding input interval. A smooth real-time transmission and presentation can thus be ensured by keeping the same packet transmission rate with the original packet input rate for the packets. A signal synchronizer is located between asynchronous units or at the input of a unit receiving packets from an asynchronous source, to ensure reliable packet transmission across the units.

### BACKGROUND OF INVENTION

The present invention relates to systems and methods for processing packet streams, and especially to systems and methods using multiple cascaded units with capability of processing real-time packet streams.

Digital broadcasting receiver systems, for example, digital TV, typically have a channel receiver, a tuner, a demultiplexer (DEMUX), a video/audio decoder, and a buffer, which decode MPEG-based data generated from a remote broadcasting transmitter system. The MPEG-based data adopts an MPEG standard that was developed by the Moving Pictures Experts Group. The MPEG standard, e.g. MPEG-1, MPEG-2, or MPEG-4, standardizes presentation, compression, and transmission of video data for various kinds of processing apparatus. The MPEG-based data consists mainly of video data, audio data, and a system control signal, which is packetized in a serial arrangement based on irregular, interleaved time intervals during data transmission. These packets serially transmitted are often referred to as “transport stream packets”. For instance, illustrated in FIG. 1B, MPEG transport steam packets 1, 2, 3, . . . are transmitted or received at time intervals A, B, C, . . . , wherein the time intervals may not be the same. Each standardized transport stream packet has only a fixed length of 188 bytes to carry video data, audio data, or control signals thereon. There is no additional space provided for other transport methods, such as a non-standard transport stream approach.

The transport stream packets are parsed to send to each related unit that processes audio or video data in the digital broadcasting receiver system, for example, audio data packets are transported into an audio decoding unit. A processing delay caused by a unit may not be equal for each transport stream packet. An additional delay between two contiguous transport stream packets passing across the same unit may cause jitter in relation to a standard clock. The jitter problem results a difference between an input rate and an output rate for the unit. The inconsistent packet input and output rates may cause the packet streams to overflow or underflow buffer resource of a receiving end in the system during packet transmission. This disrupts real-time packet transmission in the digital broadcasting receiver system. Thus, the original packet rate should be maintained.

To avoid the jitter problem, it is significant to preserve the relative time interval between any two contiguous transport stream packets to maintain the same packet-steaming rate for both the input and output of the unit.

To establish a digital home architecture, units of the digital broadcasting receiver system including peripherals are typically connected for distribution of digital contents. The units or peripherals may include set-top boxes, personal computers, audio or video playing devices, recording devices, photo printers, etc. For example, the digital contents of a specific digital program are stored in a digital recorder while supplying to a digital television (DTV) for display. These units or peripherals may be connected via an IEEE-1394 bus interface.

The IEEE-1394 Bus interface defines a packet transport mechanism for transporting multiple, high speed, and real-time digital audio and video packet streams between devices. The IEEE 1394 standard also recognizes the 188 bytes of the MPEG-based transport stream packets. The IEEE-1394 standard cannot provide an additional space for transporting non-MPEG packets, for example, 192 bytes, which contains a time stamp of 4 bytes attached therein.

To ensure real-time transmission of a stream of transport stream packets across different types of units of digital broadcasting systems, packet transmission input and output rates of each unit should remain consistent for each individual packet.

However, if any unit of the digital broadcasting receiver systems uses a clock asynchronous with respect to the other units, real-time transmission of the stream of transport stream packets among the units may not be guaranteed.

### SUMMARY OF THE INVENTION

To address the drawbacks of the above-mentioned prior technology, some embodiments of the present invention provide systems and methods for processing packet streams, which ensure the same output rate as the input rate for each packet. Embodiments of the packet stream processing systems comprise multiple cascaded units each having a packet rate compensation mechanism to maintain time intervals of a series of transport stream packets across the unit thereby maintaining a consistent packet-streaming rate for both input and output of the unit. Thus, a real-time transmission and presentation can be ensured without jitter distortion.

Some embodiments of the systems and methods for processing packet streams utilize a signal synchronizer to store and transmit a series of transport stream packets across an interconnection between two asynchronous-clock units.

The packet stream processing systems comprise multiple cascaded units for processing one-way packet streams. Each unit has a packet rate compensator for adjusting the packet output rate of the unit to be consistent with the packet input rate of the same unit, thereby maintaining an output interval of the stream of the packets approximately the same as a corresponding input interval across the unit. In some embodiments, the packet rate compensator includes a time-stamp generator, a storage device, a comparative apparatus, and a stamp remover. The time-stamp generator generates a time stamp, based on a timing source, for each packet received from entry of the unit. The time stamp may be tagged with or attached to the packet. The comparative apparatus determines whether to transport the packet to the next unit, according to a comparison result between the time stamp of the packet and a time value provided by the timing source. The stamp remover removes the time stamp generated for the packet before the packet is transported to the next unit. Successive packets are serially transmitted via one or more interconnections among the units at approximately the same packet-streaming rate, which ensures jitter robustness real-time transmission and presentation. A signal synchronizer is allocated between each two units that may be time-base independent.

Some embodiments of the packet stream processing method for multiple cascaded units process a series of packets. An exemplary method comprises compensating a packet output rate of a first unit to be consistent with a packet input rate of the first unit thereby maintaining each output interval of the series of packets approximately the same as a corresponding input interval across the first unit, subsequently transmitting the series of packets from the first unit to a second units, and compensating a packet output rate of the second unit to be consistent with a packet input rate of the second unit thereby maintaining each output interval of the series of packets approximately the same as a corresponding input interval across the second unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a schematic diagram of an embodiment of the packet stream processing system having multiple cascaded units;

FIG. 1B illustrates a schematic diagram showing a series of packets with variable intervals;

FIG. 1C illustrates a schematic diagram of an exemplary packet rate compensator as shown in FIG. 1A;

FIG. 2 illustrates a schematic diagram of an exemplary DTV system implementing an embodiment of the present invention;

FIG. 3 illustrates a schematic diagram showing an embodiment of a packet stream processing system having multiple cascaded units and signal synchronizers;

FIG. 4 illustrates a schematic diagram showing an embodiment of a DTV system implementing the embodiment as shown in FIG. 3; and

FIG. 5 illustrates a flow chart of an embodiment of the packet stream processing method for multiple cascaded units.

### DETAILED DESCRIPTION

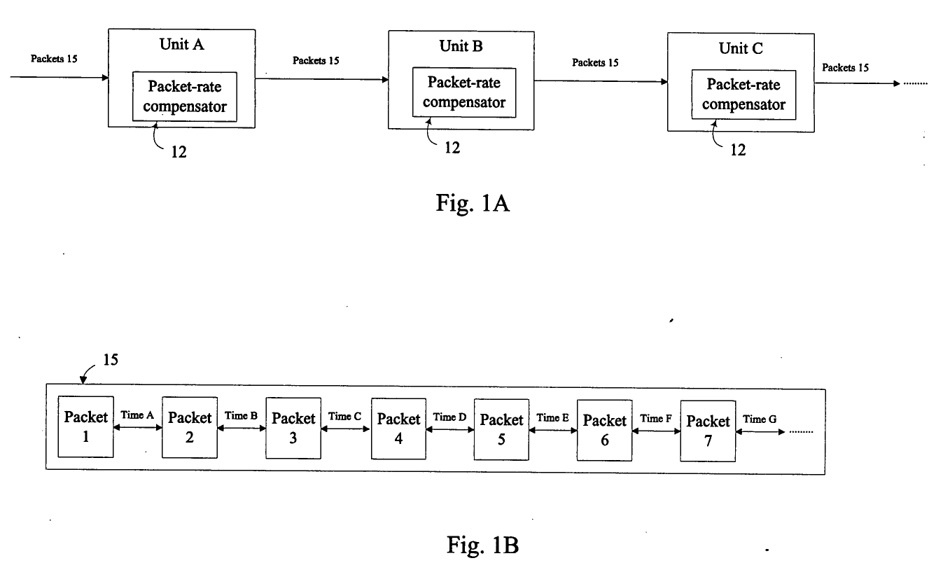

FIG. 1A shows an embodiment of a packet stream processing system 1, which comprises multiple cascaded units A, B, C, . . . for processing a packet stream 15. Initially, a plurality of packets in the packet stream 15 are serially received by the unit A.

As shown in FIG. 1B, the packet stream 15 comprises transport stream packets 1, 2, 3, 4, 5, 6, 7, . . . , which are separated by predetermined non-uniform time intervals A, B, C, D, E, F, G, . . . , respectively. Each packet may carry video data, audio data, system control signal, or a combination thereof. During packets transmission across units of a conventional processing system, some packets are distributed over or processed by the units on demands, thus a time interval between successive packets may not be the same as the original packet arrangement due to data consumption or transmission delay.

In FIG. 1A, each of the units A, B, C, . . . utilizes a packet rate compensator 12 to maintain the predetermined time intervals defined among the packet stream 15. The packet rate compensator 12 compensates each packet output rate of the unit to be consistent with a packet input rate of the same unit. The packet rate compensator 12 can be designed as and implemented by hardware logic, software, or firmware.

FIG. 1C illustrates an exemplary packet rate compensator 12 of FIG. 1A, which includes a time-stamp generator 122, a storage device 126, a comparative apparatus 128, and a stamp remover 129. Upon arrival of each packet at the input of a unit, the time-stamp generator 122 generates a corresponding time stamp for the arrived packet depending on a timing source 124. The timing source 124 may be a local timer or derived from other apparatus, which typically includes a counter triggered by a clock signal. The clock signal is generated by a clock signal generator such as an oscillator. In some embodiments, the time stamp may be tagged to a packet of standardized or non-standardized byte length, or the time stamp may be generated independent of the corresponding packet, and stored in a storage device 126. In some other embodiments, a program clock reference (PCR) existing in the packet derived from other system may serve as a time stamp of the packet in the system 1. The storage device 126 in the packet rate compensator 12, such as DRAM or SRAM, is used to successively store each packet in preparation for streaming the packet from the current unit to a subsequent unit (for example, from unit A to unit B as shown in FIG. 1A). Alternatively, the storage device 126 may be an existing memory not located in the packet rate compensator 12 but can be accessed by the packet rate compensator 12.

The comparative apparatus 128 such as a comparator is utilized to compare the time stamp with a timing value provided by the timing source 124, and it determines whether to transmit the packet to the subsequent unit according to the comparison result. The comparative apparatus 128 determines to output the packet when a certain comparison result between the time stamp of the packet and the timing value generated from the timing source 124 is met. This certain comparison result is met, for example, when the time stamp of the packet is identical to the timing value generated from the timing source 124, or when the timing value is equal to the time stamp added by a specific offset or delay value. For other embodiments of packet rate compensator, for example, the PCR serving as a time stamp is extracted from the packet and then is compared with a local timer.

As a result, the current unit outputs the packet stream 16 with approximately the same time intervals as the input packet stream 15. The packet-output rate of the current unit is kept consistent with the packet-input rate of the same unit. In some embodiments, the packet transmission rate for each packet is kept constant for both input and output. In some other embodiments, an average packet transmission rate for a predetermined time interval is kept constant for both input and output. The stamp remover 129 strips the time stamp corresponding to the packet before the packet is transmitted to the subsequent unit.

In FIG. 1A, the packet stream 16 derived from the packet stream 15, is output from units A to B, and the packet transmission rates for packet streams 15 and 16 are controlled by the packet rate compensator 12 of unit A. Similarly, the packet stream 16 may be transmitted to unit B and unit C and packet streams 17 and 18 are generated, respectively. The packet transmission rate or time intervals between successive packets of these packet streams 17 and 18 are also carefully controlled by the packet rate compensators 12 of unit B and unit C. As a result, the original transmission rate for each packet in the packet stream 15 can be maintained to ensure smooth real-time transmission and presentation.

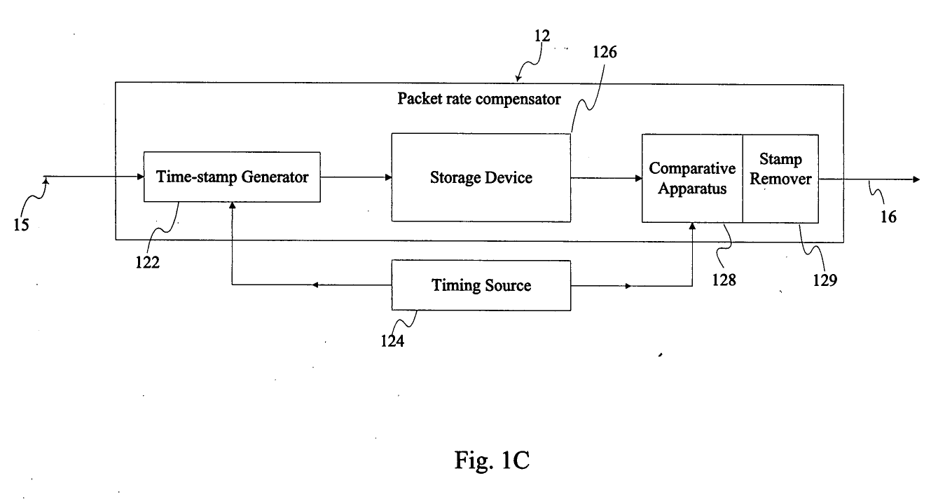

FIG. 2 shows an exemplary DTV decoding system 2 implementing the packet stream processing system as shown in FIG. 1A. The DTV decoding system 2 capable of recording comprises a channel receiver 22 (including a tuner and demodulator), a transport stream demultiplexer (TS DEMUX) 24, an IEEE 1394 interface 26, and a digital storage apparatus 28. The demultiplexer 24 and the IEEE 1394 interface 26 are embodiments of the multiple units in FIG. 1A. Initially, a TS packet stream 200 is received from the channel receiver 22 and sent to the TS demultiplexer 24 having a packet rate compensator 244. Under the rate control of the packet rate compensator 244, the TS packet stream 202 is transferred from the TS demultiplexer 24 to the IEEE 1394 interface 26. The packet output rate of transmitting the TS packet stream 202 from the TS demultiplexer 24 is controlled by the packet rate compensator 244 to be consistent with the packet input rate of the TS packet stream 200 received by the TS demultiplexer 24. Similarly, the TS packet stream 204 is transmitted at approximately the same packet transmission rate from the IEEE 1394 interface 26 to the digital storage apparatus 28 under the rate control of the packet rate compensator 264.

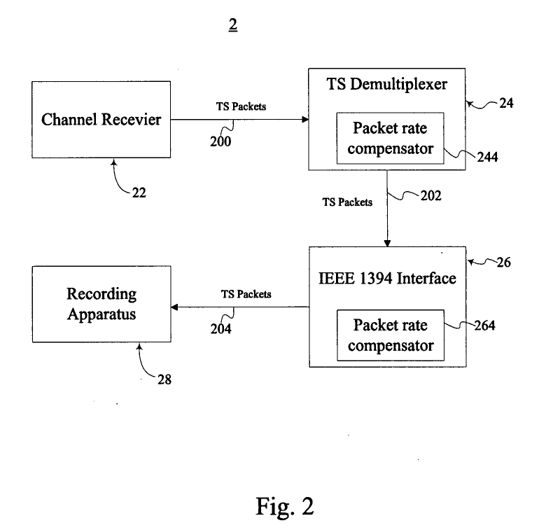

Alternatively, FIG. 3 shows a packet stream processing system 3 according to another embodiment, which comprises multiple units A′, B′, and C′. The clock source for each of these units A′, B′, C′ may be different with respect to the other units. As stated previously, each unit uses a packet rate compensator 32 to ensure consistence of the packet output rate with the packet input rate for the same unit.

In contrast to the previous embodiments such as the system 1 as shown in FIG. 1A, each of the units A′, B′, C′of the system 3is coupled to at least a signal synchronizer 30. Each unit A′, B′, C′receives a packet stream 15, 16, 17 from such a signal synchronizer 30 since the units A′, B′, C′could be time-base independent. The signal synchronizer 30 may be coupled to an input of a unit, buffering input packets to prevent failure induced by receiving the packets from an asynchronous input source. In some said embodiments, successive units operating based on the same timing source may not require a signal synchronizer for unit connecting and packet buffering. The signal synchronizer 30 may comprises an asynchronous queuing buffer (e.g. an asynchronous FIFO buffer or the like), or can be realized by an asynchronous interface/circuit coupling to the FIFO buffer. The signal synchronizer 30 is used to sequentially store the packets and then transmit the packet to the subsequent unit. The signal synchronizer 30 may eliminate the packet dropping problem occurred when transmitting packets between clock-asynchronized units thereby maintaining reliable packet transmission among units.

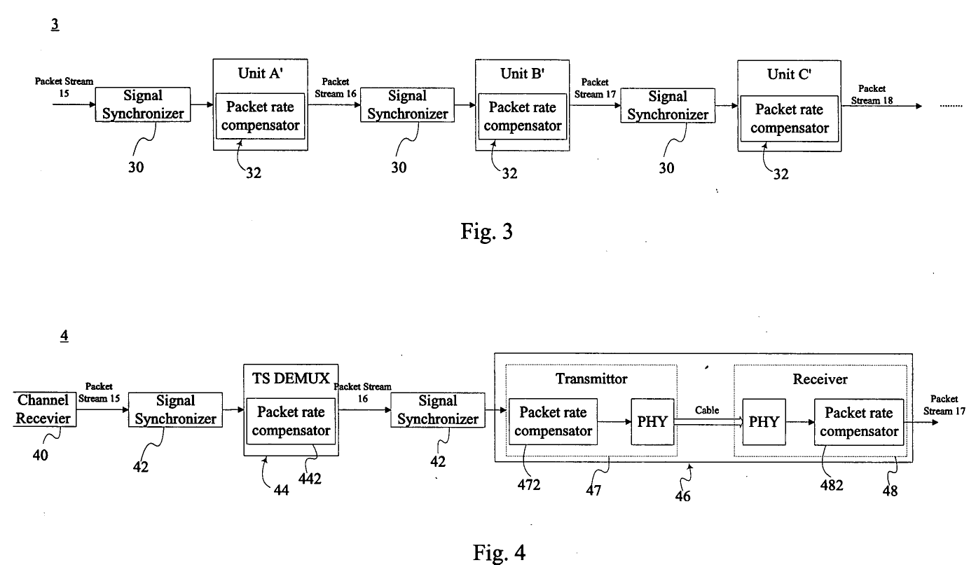

FIG. 4 shows another exemplary DTV decoding system 4 implementing an embodiment of the packet stream processing system shown in FIG. 3. The DTV decoding system 4 receives a packet stream 15 from a channel receiver 40 (including a tuner and demodulator), and the packet stream 15 is sent to a TS demultiplexer 44 via a signal synchronizer 42. The DTV decoding system 4 further comprises another signal synchronizer 42 transmitting a packet stream 16 from the TS demultiplexer 44 to a transmitting-end IEEE 1394 interface 47. The transmitting-end IEEE 1394 interface 47 further transfers the packet stream 16 to a receiving-end IEEE 1394 interface 48 via a cable. Noted that there is no signal synchronizer located between the two IEEE 1394 interfaces 47 and 48 because the two interfaces are expected to be synchronized. The receiving-end IEEE 1394 interface 48 may send a packet stream 17 to a recording device such as a digital VHS storage apparatus. Each unit 44, 47, or 48 comprises a packet rate compensator 442, 472, or 482 for maintaining the consistent packet input and output rates.

Since the clock fed to the TS demultiplexer 44, the channel receiver 40, and the IEEE 1394 interfaces 47 and 48 may be asynchronous in frequency or phase, the two signal synchronizers 42 are required as the interconnections among the units.

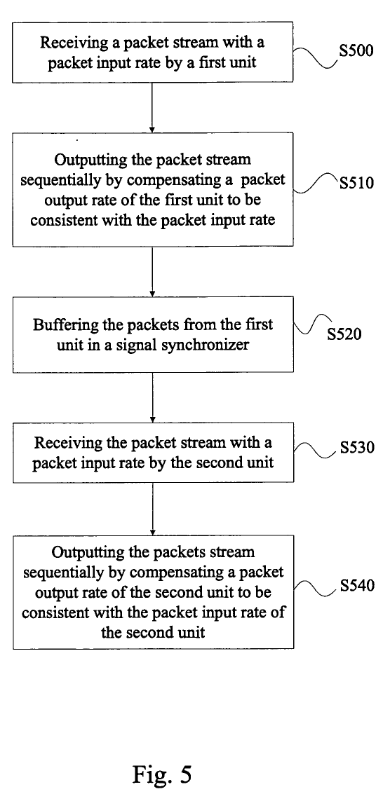

FIG. 5 is a flow chart depicting a packet stream processing method for multiple cascaded units. The multiple cascaded units include at least one first and second units. The method comprises the following steps:

Step S500: receiving a packet stream with a packet input rate by the first unit, wherein the packet input rate may be determined according to various time intervals between packets in the packet stream;

Step S510: outputting the packets of the packet stream sequentially by compensating a packet output rate of the first unit to be consistent with the packet input rate of the first unit;

Step S520: buffering the packets output from the first unit in a signal synchronizer for transmitting the packet stream with the packet output rate of the first unit to the second unit;

Step S530: receiving the packet stream with a packet output rate from signal synchronizer by the second unit; and

Step S540: outputting the packets of the packet stream sequentially by compensating a packet output rate of the second unit to be consistent with the packet input rate of the second unit.

An embodiment of compensating a packet output rate comprises generating a time stamp for arrival of at least one of the packets according to a timing source, temporarily storing the packet with the generated time stamp, determining the packet output rate by controlling the departure timing for the packet according to a comparison result between the generated time stamp and a timing value provided by the timing source, and removing the time stamp corresponding to the packet before departure of the packet.

In summary, the present invention discloses systems and methods for processing packet stream. In some embodiments, the system comprises multiple cascaded units, each having a packet rate compensation mechanism to maintain predetermined time intervals defined within a series of packets across the unit, thereby maintaining a consistent packet transmission rate at both input and output of the unit.

Certain terms are used throughout the description and claims to refer to particular system components. As one skilled in the art will appreciate, consumer electronic equipment manufacturers may refer to a component by different names. This document does not intend to distinguish between components that differ in name but not function. The term “couple” is intended to mean either an indirect or direct electrical connection.

Those skilled in the art will readily observe that numerous modifications and alterations of the claimed device and method of the present invention may be made while retaining the teachings of the invention. Accordingly, the above disclosure should be construed as limited only by the metes and bounds of the appended claims.

What is claimed is:

1. A system for processing a packet stream, comprising:
multiple cascaded units for processing the packet stream serially, each having
a time-stamp generator generating a time stamp according to a timing source, corresponding to arrival of at least one packet at the unit; and
a comparative apparatus determining whether to transmit the packet to the next unit, according to the time stamp of the packet and a timing value provided by the timing source, to maintain an interval of packets output from the unit approximately the same as a corresponding input interval, thereby maintaining a consistent packet transmission rate.

2. The system as defined in claim 1, wherein the multiple units comprises a demultiplexer, a transmitting-end IEEE 1394 interface, a receiving-end IEEE 1394 interface, a recording apparatus, a playing apparatus, and display apparatus.

3. The system as defined in claim 1 wherein the time stamp indicates an arrival time of the packet at the unit.

4. The system as defined in claim 1 wherein the timing source comprises a counter triggered by a clock signal.

5. The system as defined in claim 1 wherein each unit further comprises a storage device coupled to the time-stamp generator, which buffers the packets for preparation of transmitting the packet to the next unit.

6. The system as defined in claim 1 wherein the comparative apparatus determines transmission of the packet to the next unit if a certain comparison result of comparing the time stamp with the timing value is met.

7. The system as defined in claim 6 wherein the certain comparison result is that the time stamp of the packet is identical to the timing value provided by the timing source.

8. The system as defined in claim 1 further comprising a stamp remover for removing the time stamp corresponding to the packet before the packet is transmitted to the next unit.

9. The system as defined in claim 1 wherein the packet transmission rate can be an average rate for a predetermined interval.

10. The system as defined in claim 1 further comprising a signal synchronizer coupled to an input of a unit, buffering input packets to prevent failure induced by receiving the packets from an asynchronous input source.

11. The system as defined in claim 10 wherein the signal synchronizer comprises an asynchronous queuing buffer that subsequently stores the input packets of the packet stream.

12. A method for processing a packet stream among multiple cascaded units that includes at least a first and second units, comprises the steps of
receiving the packet stream with a first packet input rate by the first unit;
outputting the packet stream sequentially by compensating a first packet output rate of the first unit to be consistent with the first packet input rate of the first unit;
buffering the packets stream output from the first unit in a signal synchronizer;
receiving the packet stream with a second packet input rate transmitted from the signal synchronizer by the second unit; and
outputting the packet stream by compensating a second packet output rate of the second unit to be consistent with the second packet input rate of the second unit.

13. The method as defined in claim 12 wherein the first and second units are time-base independent.

14. The method as defined in claim 12 wherein the first packet input rate can be determined according to various time intervals between packets in the packet stream.

15. The method as defined in claim 13 wherein the signal synchronizer prevents the packets from being dropped in packet transmission between the first and second units thereby maintaining reliable packet transmission between units.

16. A method for processing a packet stream among multiple units, comprising the steps of:
generating a time stamp for arrival of at least one of the packets at one of the units according to a timing source;
temporarily storing the packet with the generated time stamp in the unit;
determining a packet output rate by controlling a departure timing of the packet from the unit, according to a comparison result between the generated time stamp and a timing value provided by the timing source; and
removing the time stamp corresponding to the packet before departure of the packet.
